(19) United States
(12) Patent Application Publication
(10) Pub. No.: US 2025/0161872 A1
(43) Pub. Date: May 22, 2025

(54) GAS TREATMENT APPARATUS FOR TREATING NITROGEN OXIDE EXHAUST USING OZONE

(71) Applicant: JING YUAN TECHNOLOGY CO., LTD., Hsinchu County (TW)

(72) Inventor: CHING-HUAN SUN, New Taipei City (TW)

(73) Assignee: JING YUAN TECHNOLOGY CO., LTD., Hsinchu County (TW)

(21) Appl. No.: 18/939,569

(22) Filed: Nov. 7, 2024

(30) Foreign Application Priority Data
Nov. 16, 2023 (TW) 112144185

(51) Int. Cl. B01D 53/56; B01D 53/75; B01D 53/76; B01D 53/86

(52) U.S. Cl. CPC B01D 53/56; B01D 53/75; B01D 53/76; B01D 53/8675; B01D 2251/104; B01D 2257/404; B01D 2258/0216; B01D 2259/10; B01D 2259/122

(57) ABSTRACT

A gas treatment apparatus for treating nitrogen oxide exhaust using ozone includes an ozone generator; a mass flow controller, controlling the gas flow amount flowing to the ozone generator; a reaction chamber; and a neutralizing chamber, provided with a third gas inlet and a fourth gas outlet. The reaction chamber includes an ozone inlet located on the side of the reaction chamber, an ozone sprayer installed inside the reaction chamber and connected to the ozone inlet, an exhaust gas inlet located on the top surface of the reaction chamber away from the center, an exhaust gas inlet tube and a third gas outlet. The exhaust gas inlet tube is provided with a connecting end and an inclined end. The inclined end and the exhaust gas inlet are connected to the outer side of the top of the reaction chamber.

### CROSS REFERENCE TO RELATED APPLICATION

All related applications are incorporated by reference. The present application is based on, and claims priority from, Taiwan Application Serial Number 112144185 filed on Nov. 16, 2023, the disclosure of which is hereby incorporated by reference herein in its entirety.

### TECHNICAL FIELD

The present disclosure relates to a gas treatment apparatus for nitrogen oxide exhaust gas, particularly a gas treatment apparatus for treating nitrogen oxide exhaust with ozone.

### BACKGROUND

Air pollution has always been an important environmental issue of concern to all walks of life around the world. Although the factors causing air pollution are all-encompassing, with the rapid development of human industrial scale, air pollution problems caused by human industrial activities have accelerated the deterioration of the atmosphere and ecology the environment, such as the greenhouse effect, PM2.5, ozone layer rupture, acid rain, etc., not only seriously affects human life and health, but also leads to global warming and extreme and drastic climate changes, which have caused urgent danger to the earth on which humans and all living things depend.

The United Nations and countries around the world have clearly established consensus goals to curb global warming and slow down the rate of global warming by limiting and reducing greenhouse gas emissions. In accordance with the provisions of Article 3, Paragraph 2 of Taiwan's “Measures for the Administration of Greenhouse Gas Emissions Inventory Registration”: “The types of greenhouse gases included in the emission inventory in the preceding paragraph are as follows:
1. Carbon dioxide.
2. Methane.
3. Nitrous oxide.
4. Hydrofluorocarbons.
5. Perfluorocarbons.
6. Sulfur hexafluoride.
7. Nitrogen trifluoride.
8. Other substances announced by the central competent authority.

The above-mentioned greenhouse gases have different degrees or impact mechanisms on global warming. For example, taking nitrous oxide (N2O) as an example, N2O is currently the most important emission that damages the ozone layer and is also the third most powerful greenhouse gas discharged into the atmosphere, after carbon dioxide and methane. The United Nations Environment Program issued a report “Drawing Down N2O to Protect Climate and the Ozone Layer” which points out that nitrous oxide can seriously deplete the ozone layer and produce a greenhouse effect. Its hazard ranks third among similar substances. If no action is taken, its concentration may increase by an average of 83% by 2050. Therefore, the international community must resolve and make a commitment to take action as much as possible to reduce nitrous oxide emissions.

According to the report, agriculture is the largest source of anthropogenic emissions of nitrous oxide, accounting for two-thirds of all emissions, while other major sources of nitrous oxide emissions include industry and fossil fuel combustion, biomass combustion and wastewater wait. Nitrous oxide has a high ability to absorb vacuum ultraviolet wavelengths from solar radiation and decomposes into nitrogen molecules and oxygen atoms. The decomposed oxygen atoms will further react with ozone molecules to generate oxygen molecules, reducing ozone.

Taiwan is a major semiconductor manufacturing country and has strict control standards for greenhouse gases emitted by the semiconductor manufacturing industry. Taking nitrous oxide (N2O) as an example, major semiconductor manufacturing plants continue to invest a lot of research and development costs in methods to eliminate or reduce emissions of nitrogen oxide exhaust gas (NOx) (including nitrous oxide).

Currently, common nitrogen oxide treatment methods can be divided into dry methods and wet methods. Dry nitrogen oxide treatment methods mainly include catalytic reduction and adsorption methods. The nitrogen oxide treatment methods of the wet method include direct absorption method, oxidation absorption method, redox absorption method, liquid phase absorption reduction method and complex absorption method.

If distinguished based on the purification principles of the nitrogen oxide treatment methods, they can be divided into three types: catalytic reduction methods, absorption methods and adsorption methods.

The main principle of the catalytic reduction method is to reduce NOx in the exhaust gas into pollution-free nitrogen molecules (N2) under the conditions of high temperature and the presence of a catalyst. Since this method must be carried out at a higher reaction temperature and requires the presence of a catalyst, removing nitrogen oxides from exhaust gas by catalytic reduction requires relatively large equipment investment and operating costs.

The absorption method mainly uses water or an aqueous solution of acid, alkali, chloride, etc. to absorb nitrogen oxides in the exhaust gas to achieve the effect of purifying the exhaust gas. However, the wastewater produced after absorbing nitrogen oxides needs to go through another treatment process before it can be safely discharged.

The adsorption method mainly uses specific adsorption materials, adsorbents, etc. to adsorb nitrogen oxides in exhaust gases. Since most adsorbent materials or adsorbents have a small capacity to adsorb nitrogen oxides, the adsorption method is usually only applicable and has ability to handle when the concentration of nitrogen oxides in the exhaust gas is low and the amount of exhaust gas emissions is small.

Therefore, in order to treat the waste gas containing nitrogen oxides generated in industrial processes (especially semiconductor processes) at a lower cost and with higher efficiency, and to comply with the emission standards stipulated in regulations, it is really urgent for the industry to focus and make efforts on the research and development.

### SUMMARY

In order to solve the above-mentioned deficiencies in the conventional treatment of nitrogen oxide exhaust gas, the present disclosure proposes a gas treatment apparatus for treating nitrogen oxide exhaust with ozone, which at least includes: a mass flow controller (MFC), an ozone generator, a reaction chamber and a neutralization chamber. The mass flow controller is provided with a first gas inlet and a first gas outlet. The first gas inlet is used to introduce external air or oxygen to the mass flow controller. The ozone generator is used to provide ozone and is provided with a second gas inlet and a second gas outlet. The reaction chamber is provided with an ozone inlet, an ozone sprayer, at least one exhaust gas inlet, at least one exhaust gas inlet tube and a third gas outlet. The ozone inlet is located on the side of the reaction chamber. The ozone sprayer is installed inside the reaction chamber and connected to the ozone inlet to diffuse ozone into the reaction chamber. The exhaust gas inlet is located on the top surface of the reaction chamber far apart from the center, the exhaust gas inlet tube is provided with a connecting end and an inclined end. The connecting end is used to introduce the exhaust gas to be treated into the reaction chamber. The exhaust gas inlet tube is connected to the outer side of the top of the reaction chamber by the inclined end and the exhaust gas inlet. The neutralization chamber is used to neutralize incompletely reacted ozone. It is provided with a third gas inlet and a fourth gas outlet. The neutralization chamber is filled with a neutralization catalyst. The above-mentioned first gas outlet and the second gas inlet are connected through the first pipeline, the second gas outlet and the ozone inlet are connected through the second pipeline, and the third gas outlet and the third gas inlet are connected through the third pipeline.

According to the gas treatment apparatus for treating nitrogen oxide exhaust with ozone according to an embodiment of the present disclosure, the number of exhaust gas inlets is 2, and each is connected to an exhaust gas inlet tube, and each exhaust gas inlet is connected to an exhaust gas inlet tube. The connection end of the exhaust gas inlet tube is further provided with a connection valve for controlling the opening and closing of the connection end. In another embodiment of the present disclosure, the gas treatment apparatus for treating nitrogen oxide exhaust with ozone is provided, wherein the number of exhaust gas inlets is 2 to 8, and each of them is connected to an exhaust gas inlet tube. The connecting end of each exhaust gas inlet tube is further provided with a connecting valve to control the opening and closing of the connecting end.

According to the gas treatment apparatus for treating nitrogen oxide exhaust with ozone according to one embodiment of the present disclosure, the inclined end of the exhaust gas inlet tube and the top surface of the reaction chamber form an axial inclination angle S, and when the inclined end of the exhaust gas inlet tube is mapped on the top surface of the reaction chamber, it forms an incident angle W with the center connecting line connecting the centers of the exhaust gas inlet and the top of the reaction chamber, and the axial inclination angle S is about 30°˜60°, and the incident angle is about 30°˜70°, thereby allowing the exhaust gas introduced into the reaction chamber to flow downward in a vortex.

According to the gas treatment apparatus for treating nitrogen oxide exhaust with ozone according to an embodiment of the present disclosure, the ozone sprayer is an L-shaped hollow pipe with an air inlet end and a sprayer end. The air inlet end is connected to the ozone inlet, and the opening of the sprayer end faces the top of the reaction chamber, so that the introduced ozone flow is reversed to the flow direction of the exhaust gas introduced into the reaction chamber to increase the collision efficiency of ozone molecules and nitrogen oxide exhaust gas molecules.

In another embodiment of the present disclosure, the gas treatment apparatus for treating nitrogen oxide exhaust with ozone is provided, wherein the ozone sprayer is an L-shaped hollow pipe with an air inlet end and a sprayer end, the air inlet end is connected to the ozone inlet, and the opening of the sprayer end faces the top of the reaction chamber. There is a Y-shaped blocking element in the opening of the sprayer end. The Y-shaped blocking element has a support part and a cone-shaped blocking part. One end of the support part is at the bottom of the opening of the sprayer end, the other end is connected to the top of the cone-shaped blocking part so that the bottom end of the cone-shaped blocking part faces the opening of the sprayer end. The bottom area of the cone-shaped blocking part is slightly smaller than the opening area of the sprayer end to form an annular sprayer slit that allows ozone to flow therethrough and then diffuse outward.

According to the gas treatment apparatus for treating nitrogen oxide exhaust with ozone according to an embodiment of the present disclosure, the ozone sprayer is an L-shaped hollow pipe with an air inlet end and a sprayer end. The air inlet end is connected to the ozone inlet, and the opening of the sprayer end faces the top of the reaction chamber. A Y-shaped blocking element is provided in the opening of the sprayer end. The Y-shaped blocking element has a support part and a conical disk blocking part, wherein the support part is a hollow cylinder made of breathable material, which includes a hollow flow channel. The top of the conical disk blocking part has a top opening. One end of the support part is located at the bottom of the sprayer end opening, and the other end is connected to the top of the conical disk blocking part, so that the hollow flow channel is connected to the top opening. There is an airflow control element disposed at an appropriate distance above the top opening. The condition of the airflow of ozone flowing through the top opening can be controlled by adjusting the distance between the airflow control element and the top opening. The bottom area of the conical disk blocking part is slightly smaller than the opening area of the sprayer end to form an annular sprayer slit, allowing ozone to flow through the sprayer slit and then diffuse outward.

According to an embodiment of the present disclosure, a gas treatment apparatus for treating nitrogen oxide exhaust with ozone is provided, wherein the ozone inlet is located within approximately ⅓ of the length of the reaction chamber from the top of the reaction chamber.

According to the gas treatment apparatus for treating nitrogen oxide exhaust with ozone according to an embodiment of the present disclosure, the reaction chamber is further provided with a shrink tube in front of the third gas outlet, so that the diameter gradually shrinks toward the third gas outlet, so that the inner diameter of the third gas outlet is approximately 40% to 60% of the inner diameter of the reaction chamber, and the length of the shrink tube accounts for approximately 5% to 20% of the total length of the reaction chamber.

According to an embodiment of the gas treatment apparatus for treating nitrogen oxide exhaust with ozone, the neutralization chamber is further provided with a heating device disposed outside the neutralization chamber for heating and controlling the temperature of the neutralization chamber.

According to an embodiment of the present disclosure, in the gas treatment apparatus for treating nitrogen oxide exhaust with ozone, the neutralizing catalyst is in granular.

### BRIEF DESCRIPTION OF THE DRA WINGS

The present disclosure will become more readily apparent to those ordinarily skilled in the art after reviewing the following detailed description and accompanying drawings, in which:

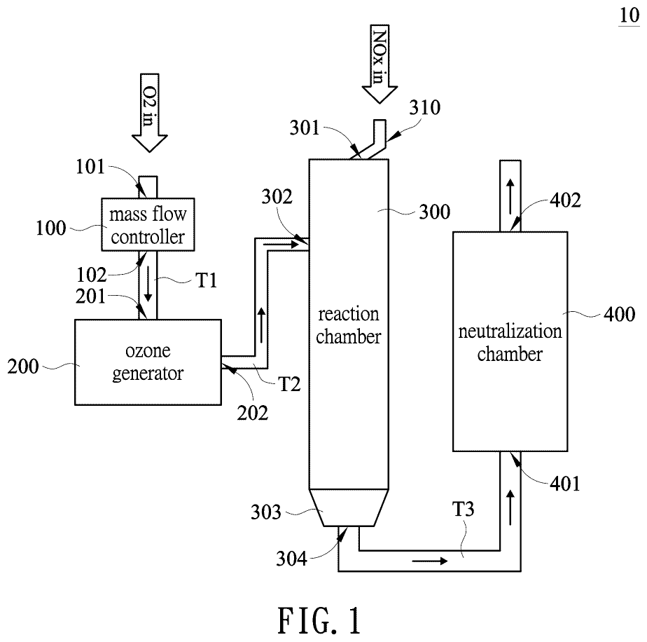

FIG. 1 is a schematic diagram of a gas treatment apparatus for treating nitrogen oxide exhaust with ozone according to an embodiment of the present disclosure.

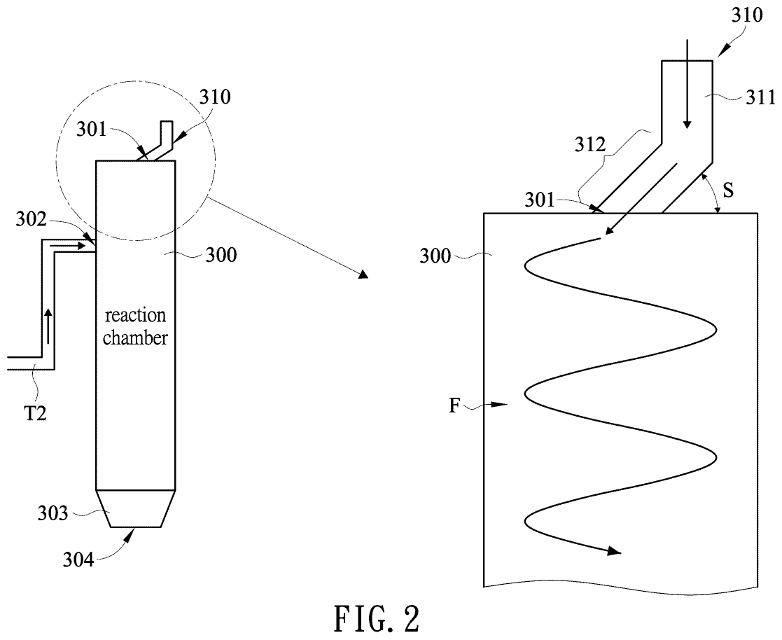

FIG. 2 is a schematic side view of the reaction chamber and the exhaust gas inlet tube of a gas treatment apparatus for treating nitrogen oxide exhaust with ozone according to one embodiment of the present disclosure.

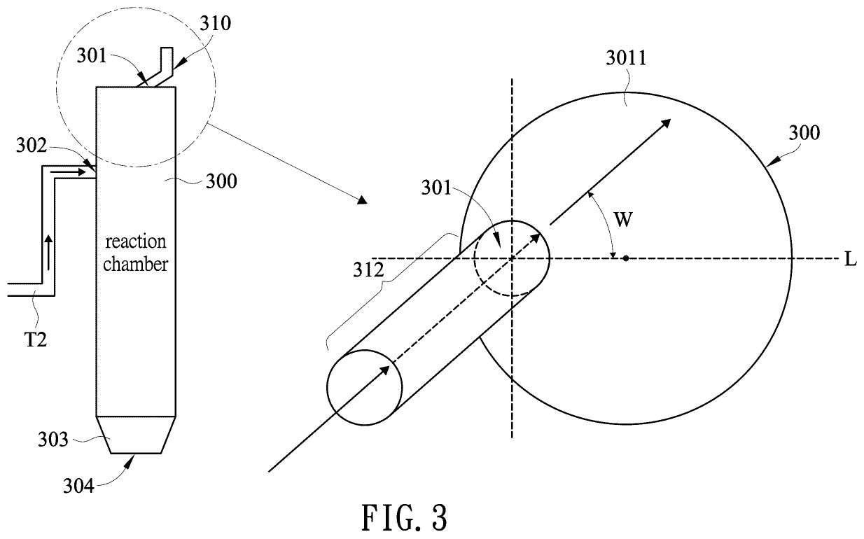

FIG. 3 is a schematic top view of the exhaust gas inlet tube and the top surface of the reaction chamber of the gas treatment apparatus for treating nitrogen oxide exhaust with ozone according to one embodiment of the present disclosure.

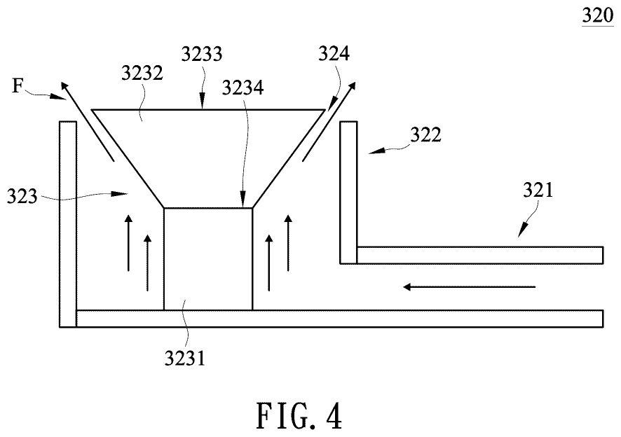

FIG. 4 is a schematic diagram of an ozone sprayer of a gas treatment apparatus for treating nitrogen oxide exhaust with ozone according to an embodiment of the present disclosure.

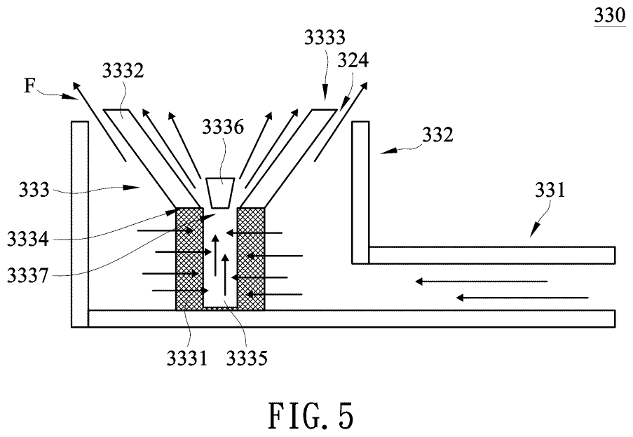

FIG. 5 is a schematic diagram of another ozone sprayer of a gas treatment apparatus for treating nitrogen oxide exhaust with ozone according to an embodiment of the present disclosure.

### DETAILED DESCRIPTION

The following will describe embodiments of the integrated heat dissipation module structure of the present disclosure with reference to relevant drawings. For the sake of clarity and convenience in the illustration, the size and proportion of each component in the drawings may be exaggerated or reduced. In the following description and/or the scope of the patent application, the technical terms used should be interpreted with the customary meanings commonly used by those of ordinary skill in the art. To facilitate understanding, the same elements in the following embodiments are referred to as the same. Symbols to illustrate. As used in this specification, the word “about” generally means that the actual value is within plus or minus 10%, 5%, 1% or 0.5% of a specific value or range. The term “about” as used herein means that actual values fall within acceptable standard errors of the mean, as would be considered by one of ordinary skill in the art to which this invention pertains. Except for the examples, or unless otherwise expressly stated, it will be understood that ranges, quantities, values and percentages used herein are modified by “about”. Therefore, unless otherwise stated, the numerical values or parameters disclosed in this specification and the accompanying patent claims are approximate values and may be changed as required.

In the description in this manual, the terms “upper”, “lower”, “front”, “rear”, “left”, “right”, “top”, “bottom”, “inner” and “outer” are used.” and other terms used to indicate the orientation or positional relationship of components are based on the orientation or positional relationship shown in the drawings. They are only used to facilitate the description of the device of the present disclosure and simplify the description, and are not intended to indicate or imply the referred device or component. Must have a specific orientation, or must be constructed and operated in a specific orientation, and therefore should not be construed as limitations on the disclosure.

Please refer to FIG. 1, which is a schematic diagram of a gas treatment apparatus for treating nitrogen oxide exhaust with ozone according to an embodiment of the present disclosure. As shown in FIG. 1, a gas treatment apparatus 10 for treating nitrogen oxide exhaust with ozone according to the present disclosure at least includes: a mass flow controller 100, an ozone generator 200, a reaction chamber 300 and a neutralization chamber 400. The mass flow controller 100 is provided with a first gas inlet 101 and a first gas outlet 102. The first gas inlet 101 is used to introduce external air or oxygen into the mass flow controller 100. The ozone generator 200 is used to provide ozone and is provided with a second gas inlet 201 and a second gas outlet 202. The reaction chamber 300 is provided with an ozone inlet 302, ozone diffusers 320 and 330 (see FIG. 4 and FIG. 5), at least one exhaust gas inlet 301, at least one exhaust gas inlet tube 310 and a t third gas outlet 304. The ozone inlet 302 is disposed on the side of the reaction chamber 300. Ozone diffusers 320 and 330 are disposed inside the reaction chamber 300 and connected to the ozone inlet 302 to diffuse ozone into the reaction chamber 300. The exhaust gas inlet 301 is located on the top surface 3011 of the reaction chamber 300 (see FIG. 3) away from the center. The exhaust gas inlet tube 310 is provided with a connecting end 311 and an inclined end 312 (see FIG. 2). The connecting end 311 is to introduce the waste gas to be treated into the reaction chamber 300, the waste gas introduction pipe 31 is connected to the outer side of the top of the reaction chamber 300 with the inclined end 312 and the exhaust gas inlet 301. The neutralization chamber 400 is used to neutralize incompletely reacted ozone. It is provided with a third gas inlet 401 and a fourth gas outlet 402. The neutralization chamber 400 is filled with a neutralization catalyst. The above-mentioned first gas outlet 102 and the second gas inlet 201 are connected through the first pipeline T1, the second gas outlet 202 and the ozone inlet 302 are connected through the second pipeline T2, and the third gas outlet 304 is connected to the third gas inlet 401 through the third pipeline T3.

To further explain, when the gas treatment apparatus 10 for treating nitrogen oxide exhaust with ozone in this embodiment is operating, external air or oxygen will be introduced into the mass flow controller 100 through the first gas inlet 101, and the mass flow rate will be controlled by the gas treatment apparatus 10. The mass flow controller 100 controls the output gas flow from the first gas outlet 102 through the first pipeline T1 and then flows into the ozone generator 200 from the second gas inlet 201. The ozone generator 200 further converts the incoming oxygen into ozone, and then flows from the second gas outlet 202 through the second pipeline T2 and then enters the inside of the reaction chamber 300 from the ozone inlet 302. Ozone diffusers 320 and 330 (see FIG. 4 or FIG. 5) are provided inside the reaction chamber 300, which are connected to the ozone inlet 302. After the ozone passes through the ozone inlet 302, it diffuses in the reaction chamber 300 through the ozone diffusers 320 and 330. At the same time, the external nitrogen oxide exhaust gas (for example: nitrous oxide, N2O) to be treated enters the reaction chamber 300 from the exhaust gas inlet tube 310 provided above and outside the top of the reaction chamber 300, and then enters the reaction chamber 300 through the exhaust gas inlet 301, and react with the ozone molecules diffused inside the reaction chamber 300. The reacted nitrous oxide generates gases such as nitrogen dioxide or dinitrogen pentoxide with high water solubility, which can be further formed into an aqueous solution to meet safe gas emission standards.

After the nitrogen oxide exhaust gas and ozone in the reaction chamber 300 are mixed and reacted, they will flow out from the third gas outlet 304 of the reaction chamber 300 and then pass through the third pipeline T3 to flow into the neutralization chamber 400 from the third gas inlet 401. The interior of the neutralization chamber 400 is filled with a neutralization catalyst. Its main function is to destroy ozone molecules that have not yet reacted completely, so that the ozone molecules are decomposed into harmless oxygen molecules, and then discharged from the fourth gas outlet 402t of the neutralization chamber 400 to the rear-end exhaust gas recovery equipment.

In one embodiment, in the gas treatment apparatus 10 for treating nitrogen oxide exhaust with ozone according to the present disclosure, the number of exhaust gas inlets 301 provided on the top of the reaction chamber 300 is 2, and each of which is connected to an exhaust gas inlet tube 310, and the connecting end 311 (see FIG. 2) of each exhaust gas inlet tube 310 is further provided with a connecting valve for controlling the opening and closing of the connecting end 311. To further explain, in order to more efficiently apply the disclosed gas treatment apparatus 10 for treating nitrogen oxide exhaust with ozone, in this embodiment, two exhaust gas introduction pipes 310 can be provided to connect two nitrogen oxide exhaust gas sources respectively and introduced into the reaction chamber 300 through the exhaust gas inlet 301. During operation, the opening and closing of the connecting end 311 of the exhaust gas inlet tube 310 can be controlled by the connecting valve of the connection end 311 to control the introduction of exhaust gas. For example: when changing the source of nitrogen oxide exhaust gas, the opening of the connection end 311 can be closed through the connection valve, and the opening of the connection end 311 can be opened after reconnecting to the nitrogen oxide exhaust gas source pipeline. In another embodiment, in order to be able to respond to and simultaneously treat the exhaust gas sources of multiple devices, in the gas treatment apparatus 10 for treating nitrogen oxide exhaust with ozone in the present disclosure, the number of exhaust gas inlets 301 disposed on the top of the reaction chamber 300 can be set to multiple, for example, 2 to 8, and each is connected to an exhaust gas inlet tube 310. The connecting end 311 of each exhaust gas inlet tube 310 (please see FIG. 2) is further provided with a connecting valve used to control the opening and closing of the connecting end 311. It should be understood that the connecting valve system is generally a common technical means for pipeline connection, so it is not further described or limited here.

Please also refer to FIG. 2 and FIG. 3. In one embodiment, in the gas treatment apparatus 10 for treating nitrogen oxide exhaust with ozone of the present disclosure, the inclined end 312 of the exhaust gas inlet tube 310 and the top surface 3011 of the reaction chamber 300 form an axial inclination angle S, and when the inclined end 312 of the exhaust gas inlet tube 310 is mapped onto the top surface 3011 of the reaction chamber 300, it forms an incident angle W with the center connecting line L connecting the centers of the exhaust gas inlet 301 and the top of the reaction chamber 300. The axial inclination angle S is approximately 30°˜60°, and the incident angle is about 30°˜70°, thereby allowing the exhaust gas introduced into the reaction chamber 300 to flow downward in a vortex (as indicated by the air flow F).

To further explain, in order to enable ozone molecules and nitrogen oxide exhaust gas molecules to mix and react more effectively, the present disclosure designs and uses the exhaust gas inlet tube 310 as disclosed in FIG. 2 and FIG. 3. Please refer to FIG. 2 first. As shown in FIG. 2, in this embodiment, the exhaust gas inlet tube 310 has a connecting end 311 and an inclined end 312. The connection end 311 is used to connect an external exhaust gas source and is arranged generally parallel to the axial direction of the reaction chamber 300, but is not limited to this. The inclined end 312 of the exhaust gas inlet tube 310 is connected to the exhaust gas inlet 301 on the top of the reaction chamber 300, and there is an axial inclination angle S between the inclined end 312 and the top surface 3011 of the reaction chamber 300 of about 30° to 60°. In addition, please also refer to FIG. 3. As shown in FIG. 3, the exhaust gas inlet 301 is disposed at a position off-center on the top surface 3011 of the reaction chamber 300. The connection line (and its extension) of the center of the exhaust gas inlet 301 and the center of the top surface of the reaction chamber 300 is L, and after the inclined end 312 of the exhaust gas inlet tube 310 is connected to the exhaust gas inlet 301, when the section of the pipeline at the inclined end 312 is mapped on the top surface 3011 of the reaction chamber 300, it and the center connecting line L presents an incident angle W of approximately 30°˜70°. In other words, the design of the inclined end 312 of the exhaust gas inlet tube 310 allows the nitrogen oxide exhaust gas to flow in a downward cyclonic vortex when it is introduced from the top of the reaction chamber 300. This design method can not only increase the path and residence time of the nitrogen oxide exhaust gas in the reaction chamber 300, but also increase the mixing and reaction efficiency of the nitrogen oxide exhaust gas and ozone. Compared with the common prior art that only uses a linear pipeline to directly introduce nitrogen oxide exhaust gas into the reaction chamber to react with ozone, the present disclosure increases the concentration of nitrogen oxide exhaust gas and ozone through the design of the inclined end 312 of the exhaust gas inlet tube 310 The collision probability of ozone molecules and the mixing reaction time can treat waste gas more efficiently.

Please refer to FIG. 4, which is a schematic diagram of an ozone sprayer of a gas treatment apparatus for treating nitrogen oxide exhaust with ozone according to an embodiment of the present disclosure. In one embodiment, in the gas treatment apparatus 10 for treating nitrogen oxide exhaust with ozone of the present disclosure, the ozone sprayer 320 is an L-shaped hollow pipe with an air inlet end 321 and a sprayer end 322, the air inlet end 321 is connected to the ozone inlet 302, and the opening of the sprayer end 322 faces the top of the reaction chamber 300, so that the introduced ozone flow is reversed to the flow direction of the exhaust gas introduced into the reaction chamber 300, so as to increase collision efficiency of ozone molecules and nitrogen oxide molecules of exhaust gas. In another preferred embodiment, as shown in the figure, in this embodiment, in the gas treatment apparatus 10 of the present disclosure for treating nitrogen oxide exhaust with ozone, the ozone sprayer 320 is an L-shaped. The hollow pipeline is provided with an air inlet end 321 and a sprayer end 322. The air inlet end 321 is connected to the ozone inlet 302, and the opening of the sprayer end 322 faces the top of the reaction chamber 300. A Y-shaped blocking element 323 is provided in the opening of the sprayer end 322. The Y-shaped blocking element 323 has a support part 3231 and a cone-shaped blocking part 3232. One end of the support part 3231 is located at the bottom of the opening of the diffusing end 322, and the other end is connected to the cone-shaped blocking part 3232. The top end 3234 of the cone-shaped blocking part 3232 is connected so that the bottom end 3233 of the cone-shaped blocking part 3232 faces the opening of the sprayer end 322. The area of the bottom end 3233 of the cone-shaped blocking part 3232 is slightly smaller than the opening area of the sprayer end 322 to form an annular sprayer slit 324, causing ozone to flow through annular sprayer slit 324 and then diffuse outward. To further explain, in this embodiment, the main function of the ozone sprayer 320 is to diffuse the ozone airflow F from the air inlet end 321 outward in a radial manner, so that the ozone molecules can be dispersed more quickly and evenly in the reaction chamber. Within the body 300, it can mix, collide and react with nitrogen oxide exhaust gas molecules faster and more efficiently. A Y-shaped blocking element 323 is provided in the opening of the sprayer end 322 of the ozone sprayer 320. The top of the Y-shape is a cone-shaped blocking portion 3232 that diffuses outward. The bottom end 3233 of the cone-shaped blocking portion 3232 (i.e., the upper opening end of the Y-shape) The area of is slightly smaller than the opening of the sprayer end 322. Therefore, when the Y-shaped blocking element 323 is disposed in the opening of the sprayer end 322, since the bottom end 3233 of the cone-shaped blocking part 3232 is approximately the same height as the plane of the opening of the sprayer end 322, the outer periphery of the bottom end 3233 of the cone-shaped blocking part 3232 will form an annular sprayer slit 324 with the opening periphery of the sprayer end 322, and the ozone airflow F from the air inlet end 321 will pass through the annular sprayer slit 324. Flows out quickly upward and outward, and diffuses in the reaction chamber 300.

Please refer to FIG. 5, which is a schematic diagram of another ozone sprayer of a gas treatment apparatus for treating nitrogen oxide exhaust with ozone according to an embodiment of the present disclosure. As shown in FIG. 5, in this embodiment, in the gas treatment apparatus 10 for treating nitrogen oxide exhaust with ozone, the ozone sprayer 330 is an L-shaped hollow pipe with an air inlet end 331 and sprayer end 332. The air inlet end 331 is connected to the ozone inlet 302, and the opening of the sprayer end 332 faces the top of the reaction chamber 300. A Y-shaped blocking element 333 is provided in the opening of the sprayer end 332. The Y-shaped blocking element 333 has a support part 3331 and a conical disk blocking part 3332, wherein the support part 3331 is a hollow cylinder made of breathable material, has a hollow flow channel 3335, the top end 3334 of the conical disc blocking part has a top opening 3337, one end of the support part 3331 is located in the opening of the sprayer end 332, the other end are connected to the top end 3334 of the conical disk blocking part 3332, so that the hollow flow channel 3335 is connected with the top opening 3337. An airflow control element 3336 is provided at an appropriate distance above the top opening 3337. By adjusting the distance between it and the top opening 3337 to control the air flow pattern of ozone flowing through the top opening 3337, the area of the bottom end 3333 of the conical disk blocking part 3332 is slightly smaller than the opening area of the sprayer end 332 to form a sprayer slit 334 which is annular-shaped, so that the ozone flows through the sprayer slit and then flows backward. external diffusion. The ozone sprayer 330 in this embodiment is different from the ozone sprayer 320 in the previous embodiment in that the Y-shaped blocking element 333 used in the ozone sprayer 330 in this embodiment has a Y-shaped opening portion. It is a conical disk blocking part 3332, and the top end 3334 of the conical disk blocking part 3332 has a top opening 3337. The support part 3331 of the Y-shaped blocking element 333 is a hollow cylinder made of breathable material and has a hollow flow channel 3335 connected with the top opening 3337. Therefore, part of the ozone gas flowing in from the air inlet end 331 can penetrate the support part 3331 and enters the hollow flow channel 3335, and then flows out from the top opening 3337 of the conical disk blocking part 3332. Through the airflow control element 3336 disposed at an appropriate distance above the top opening 3337, the ozone gas flow flowing through the top opening 3337 can be further diffused and flowed out. The ozone sprayer 330 used in this embodiment has a structure that can simultaneously allow ozone molecules to diffuse upward and outward from the top opening 3337 of the conical disk blocking part 3332 and the sprayer slit 334 which is annular, so that the ozone molecules can be dispersed more quickly and evenly in the reaction. In cavity 300, it can mix, collide and react with nitrogen oxide exhaust gas molecules faster and more efficiently.

Please refer to FIG. 1 again. As shown in FIG. 1, in a gas treatment apparatus 10 for treating nitrogen oxide exhaust with ozone according to the present disclosure, the ozone inlet 302 is located at a distance from the top of the reaction chamber 300 of about within ⅓ of the length of the reaction chamber 300, so that ozone molecules and nitrogen oxide exhaust gas molecules can have a long enough flow distance and time to collide and react. The ozone diffusers 320 and 330 disposed in the reaction chamber 300 are also disposed at this position and connected to the ozone inlet 302. As in the aforementioned embodiments, the openings of the diffusion ends 322 and 332 of the ozone diffusers 320 and 330 are facing the top of the reaction chamber 300. Therefore, the nitrogen oxide exhaust gas entering the reaction chamber 300 from the exhaust gas inlet 301 at the top of the reaction chamber 300 will collide head-on with the upward and outward diffusion of ozone flow through the openings of the diffusion ends 322 and 332 of the ozone diffusers 320 and 330 in a downward vortex, increasing the collision efficiency between ozone molecules and nitrogen oxide molecules in the exhaust gas.

Please refer to FIG. 1 again. As shown in FIG. 1, in a gas treatment apparatus 10 for treating nitrogen oxide exhaust with ozone of the present disclosure, the reaction chamber 300 is further provided with a shrink tube 303 before approaching the third gas outlet 304. The shrink tube 303 gradually shrinks the inner diameter of the reaction chamber 300 toward the third gas outlet 304, so that the inner diameter of the third gas outlet 304 is approximately 40% to 60% of the inner diameter of the reaction chamber 300, and the length of the shrink tube 303 is reduced. Accounting for about 5%˜20% of the total length of the reaction chamber 300. To further explain, in order to more efficiently increase the collision and reaction between ozone molecules and nitrogen oxide molecules in the exhaust gas, in this embodiment, a section of inner diameter is provided in front of the third gas outlet 304 of the reaction chamber 300. The shrink tube 303 gradually reduces the inner diameter of the reaction chamber 300, causing the air flow pattern inside the reaction chamber 300 to change and even cause turbulence, thereby increasing the mixing of ozone molecules and nitrogen oxide molecules in the exhaust gas. and collision, thereby increasing reaction efficiency. In addition, since ozone is also a gas that is harmful to the human body and the environment, the standard specifications for emission concentration must be observed when discharging. The design of the shrink tube 303 can also promote the complete reaction of ozone molecules.

In another embodiment of the present disclosure, in the gas treatment apparatus 10 for treating nitrogen oxide exhaust with ozone, in order to completely destroy and decompose the incompletely reacted ozone molecules into harmless ones in the neutralization chamber 400 of oxygen molecules, a heating device (not shown) can be further provided outside the neutralization chamber to heat and control the temperature of the neutralization chamber 400. Raising the temperature of the neutralization chamber 400 can not only further accelerate the reaction rate between ozone molecules and the neutralization catalyst to ensure that the concentration of ozone molecules in the treated gas discharged after the neutralization chamber 400 meets the regulatory standards, but also It can prevent water vapor in the gas from being adsorbed by the neutralizing catalyst and affecting its catalyst efficiency.

In one embodiment, the neutralizing catalyst (not shown) filled in the neutralization chamber 400 is a granular catalyst. The granular catalyst not only has a higher reaction area and can react with ozone molecules more efficiently. On the other hand, because it is filled with granular catalyst, when the gas flows into the neutralization chamber 400 from the third gas inlet 401, the pressure loss can be significantly reduced, the reaction time for ozone molecules to stay inside the neutralization chamber can be increased, and the amount of catalyst used can be reduced.

Of course, the above embodiments are only for illustration and do not limit the scope of the present disclosure. Any equivalent modifications or changes based on the gas treatment apparatus for treating nitrogen oxide exhaust with ozone should still be included in the above embodiments. within the patent scope of this disclosure.

It is worth mentioning that the gas treatment apparatus disclosed in the present disclosure that uses ozone to treat nitrogen oxide waste gas utilizes the high reactivity and reaction rate of ozone molecules to treat nitrogen oxide waste gas (especially sulfur oxide) produced in industrial processes. Nitrogen, N2O) is purified so that the treated exhaust gas can meet the emission standards or facilitate subsequent purification. In the overall purification process, no more other waste to be treated will be generated, and at the same time, no more other waste will be produced. Other replacement consumables are required. The gas treatment apparatus disclosed in this disclosure that uses ozone to treat nitrogen oxide exhaust gas is further equipped with a neutralization chamber to ensure that unreacted ozone can be further decomposed into harmless oxygen molecules before being discharged. Therefore, compared with the conventional catalytic reduction method, absorption method and adsorption method, the gas treatment apparatus of the present disclosure that uses ozone to treat nitrogen oxide exhaust gas is more cost-effective, simplifies the purification process and reduces emissions in treating nitrogen oxide exhaust gas waste and other advantages.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A gas treatment apparatus for treating nitrogen oxide exhaust with ozone, comprising:
a mass flow controller provided with a first gas inlet and a first gas outlet, wherein the first gas inlet is used to introduce external air or oxygen into the mass flow controller;
an ozone generator for providing ozone, comprising a second gas inlet and a second gas outlet;
a reaction chamber comprising an ozone inlet, an ozone sprayer, at least one exhaust gas inlet, at least one exhaust gas inlet tube and a third gas outlet, the ozone inlet is disposed on a side of the reaction chamber, the ozone sprayer is disposed inside the reaction chamber and connected to the ozone inlet for diffusing ozone into the reaction chamber, the exhaust gas inlet is disposed at a position away from a center of a top surface of the reaction chamber, the exhaust gas inlet tube is provided with a connecting end and an inclined end, the connecting end is used to introduce an exhaust gas to be treated into the reaction chamber, the exhaust gas inlet tube is connected to the exhaust gas inlet above and outside of the reaction chamber by the inclined end; and
a neutralization chamber for neutralizing incompletely reacted ozone, comprising a third gas inlet and a fourth gas outlet, and is filled with a neutralization catalyst;
wherein, the first gas outlet and the second gas inlet are connected through a first pipeline, the second gas outlet and the ozone inlet are connected through a second pipeline, and the third gas outlet is connected to the third gas inlet through a third pipeline.

2. The gas treatment apparatus for treating nitrogen oxide exhaust with ozone according to claim 1, wherein a number of the exhaust gas inlets is 2 to 8, and each of the exhaust gas inlet is connected to one exhaust gas inlet tube, and each of the exhaust gas inlets is connected to one of the exhaust gas inlet tubes, each of the connecting ends of each of the inlet pipes is further provided with a connecting valve to open or close the connecting end.

3. The gas treatment apparatus for treating nitrogen oxide exhaust with ozone according to claim 1, wherein the inclined end of the exhaust gas inlet tube and the top surface of the reaction chamber form an axial inclination angle, and when the inclined end of the exhaust gas inlet tube is reflected on the top surface of the reaction chamber, the exhaust gas inlet tube forms an incident angle with a center connecting line connecting a center of the exhaust gas inlet and a top of the reaction chamber, and the axial inclination angle is about 30°˜60°, and the incident angle is about 30°˜70°, thereby allowing the exhaust gas introduced into the reaction chamber to flow downward in a vortex.

4. The gas treatment apparatus for treating nitrogen oxide exhaust with ozone according to claim 1, wherein the ozone sprayer is an L-shaped hollow pipe with an air inlet end and a sprayer end, the air inlet end is connected to the ozone inlet, and an opening of the sprayer end faces a top of the reaction chamber, so that the introduced ozone flow is counter to a flow direction of the exhaust gas introduced into the reaction chamber, so as to increase a collision efficiency of ozone molecules and nitrogen oxide exhaust gas molecules.

5. The gas treatment apparatus for treating nitrogen oxide exhaust with ozone according to claim 4, wherein a Y-shaped blocking element is further provided in the opening of the sprayer end, and the Y-shaped blocking element has a support part and a cone-shaped blocking part, one end of the support part is located at a bottom of the opening of the sprayer end, and another end of the support part is connected to a top of the cone-shaped blocking part, so that a bottom end of the cone-shaped blocking part faces the opening of the sprayer end, and an area of the bottom end of the cone-shaped blocking part is slightly smaller than an area of the opening of the sprayer end to form a sprayer slit which is annular-shaped, allowing ozone to flow through the sprayer slit and then diffuse outward.

6. The gas treatment apparatus for treating nitrogen oxide exhaust with ozone according to claim 4, wherein a Y-shaped blocking element is further provided in the opening of the sprayer end, and the Y-shaped blocking element has a support part and a conical disk blocking part, wherein the support part is a hollow cylinder made of breathable material and has a hollow flow channel, a top of the conical disk blocking part has a top opening, one end of the support part is located at a bottom of the opening of the sprayer end, and another end of the support part connected to the top of the conical disk blocking part, the hollow flow channel is connected to the top opening, an airflow control element is provided at an appropriate distance above the top opening, and the ozone flow through the top opening is controlled by adjusting the distance between the airflow control element and the top opening, an area of a bottom end of the conical disk blocking part is slightly smaller than an area of the opening of the sprayer end to form a sprayer slit which is annular-shaped, so that ozone flows through the sprayer slit and then diffuses outward.

7. The gas treatment apparatus for treating nitrogen oxide exhaust with ozone according to claim 1, wherein the ozone inlet is located within approximately ⅓ of a length of the reaction chamber from a top of the reaction chamber.

8. The gas treatment apparatus for treating nitrogen oxide exhaust with ozone according to claim 1, wherein the reaction chamber is further provided with a shrinking tube in front of the third gas outlet to gradually reduce an inner diameter of the reaction chamber toward the third gas outlet so that an inner diameter of the third gas outlet is approximately 40% to 60% of the inner diameter of the reaction chamber.

9. The gas treatment apparatus for treating nitrogen oxide exhaust with ozone according to claim 7, wherein a length of the shrink tube accounts for approximately 5% to 20% of a total length of the reaction chamber.

10. The gas treatment apparatus for treating nitrogen oxide exhaust with ozone according to claim 1, wherein the neutralization chamber is further provided with a heating device disposed outside the neutralization chamber for heating and controlling a temperature of the neutralization chamber.

11. The gas treatment apparatus for treating nitrogen oxide exhaust with ozone according to claim 1, wherein the neutralizing catalyst is granular.
